(19) United States
(12) Patent Application Publication
(10) Pub. No.: US 2013/0192135 A1
(43) Pub. Date: Aug. 1, 2013

(54) SYSTEMS AND METHODS FOR SELECTION OF INDIVIDUAL SEEDS AND PLACEMENT ONTO SEED TAPE

(71) Applicants: Kevin L. Deppermann, St. Charles, MO (US); Brian Jacob Forinash, Kirkwood, MO (US); Travis Frey, Brentwood, MO (US); Marcus McNabnay, Edwardsville, IL (US); Charles Larry Badino, Eureka, MO (US); Andrew M. Singleton, Manchester, MO (US)

(72) Inventors: Kevin L. Deppermann, St. Charles, MO (US); Brian Jacob Forinash, Kirkwood, MO (US); Travis Frey, Brentwood, MO (US); Marcus McNabnay, Edwardsville, IL (US); Charles Larry Badino, Eureka, MO (US); Andrew M. Singleton, Manchester, MO (US)

(73) Assignee: MONSANTO TECHNOLOGY LLC, St. Louis, MO (US)

(21) Appl. No.: 13/637,319

(22) PCT Filed: Mar. 16, 2011
(86) PCT No.: PCT/US11/28661

§ 371 Date: Jan. 18, 2013

Related U.S. Application Data
(60) Provisional application No. 61/317,909, filed on Mar. 26, 2010.

(51) Int. Cl. A01C 1/04

(52) U.S. Cl. CPC A01C 1/042
USPC 47/56

(57) ABSTRACT

Systems and methods are disclosed for the selection of individual seeds from a plurality of seeds and placement on a seed tape. The system includes a seed extraction assembly, a distribution manifold, and a tamping assembly. The seed extraction assembly is configured to extract selected individual seeds from a tray, the seed extraction assembly movably attached to a frame. The distribution manifold has a plurality of queues and each of the plurality of queues has a plurality of reservoirs for receiving the selected individual seeds. Each queue has a tube in selective communication with the plurality of reservoirs for the transfer of the selected individual seed from the reservoir to the tube. The tamping assembly is configured to place the selected individual seed disposed in each of the tubes onto a defined location on the seed tape.

### FIELD

This disclosure generally relates to seed and seed tape, more specifically, to selection and placement of individual seeds on a seed tape.

### BACKGROUND

Seeds may be placed on or in a substrate to facilitate the accurate placement of seeds, such as in research or trial planting applications. The substrate may be a paper-like substance and is commonly referred to as “seed tape” or simply “tape”. Typically, seeds are uniformly spaced-apart on the tape, thus facilitating uniform spacing of plants grown from the seeds. The uniform spacing of the seeds may also reduce the need to thin the plants. The seeds can be attached to the tape by any suitable method, such as adhesive bonding or placement between two layers of the tape. Other substances, such as herbicide or fertilizer, may be disposed on the tape to aid in the growth and development of the seed. The seed tape may be wound into a roll or coil prior to planting.

In operation, the seed tape is planted in the soil by a planter pulled behind a prime mover (e.g., a tractor). At some point after planting of the seed tape, the tape may biodegrade or dissolve so that it does not inhibit the germination of the seeds.

During research operations individual seeds may be tested for the possession of certain genetic traits or other genetic information. Previous systems have only sought to place specific types or varieties of seeds onto a seed tape. Previous systems are not capable of selecting a specific, individual seed and placing the seed on the seed tape at a defined location. These previous systems have thus generally yielded unsatisfactory results in the placement of individually identified seeds on the seed tape.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect is a system for selecting individual seeds from a plurality of seeds and placing the selected individual seeds on a seed tape. The system comprises a seed extraction assembly, a distribution manifold, and a tamping assembly. The seed extraction assembly is configured to extract selected individual seeds from a tray and is movably attached to a frame. The distribution manifold has a plurality of queues. Each of the plurality of queues has a plurality of reservoirs for receiving the selected individual seeds. Each queue has a tube in selective communication with the plurality of reservoirs for the transfer of the selected individual seed from the reservoir to the tube. The distribution manifold is attached to the frame. The tamping assembly is attached to the frame adjacent the distribution manifold and is configured to place the selected individual seed disposed in each of the tubes onto a defined location on the seed tape.

Another aspect is a system for the transfer of individually identified seeds from a tray onto a seed tape. The system comprises a seed extraction assembly, a distribution manifold, and a tamping assembly. The seed extraction assembly is configured for the extraction of the individually identified seeds from the tray. The seed extraction assembly is movable relative to a frame and the tray is disposed within the frame. The distribution manifold has a plurality of queues. Each of the plurality of queues has a plurality of reservoirs for receiving individually identified seeds from the seed extraction assembly. Each queue has a tube selectively fed with individually identified seeds from one of the plurality of reservoirs in the queue. The distribution manifold is attached to the frame. The tamping assembly is configured for placing individually identified seeds from the tubes onto the seed tape.

Still another aspect is a method of placing individually identified seeds onto a seed tape. The method comprises selecting an individually identified seed from a plurality of individually identified seeds disposed in a tray and extracting the selected seed from the tray with a seed extraction assembly. These first two steps are repeated for a plurality of individually identified seeds. The seed extraction assembly is then moved to a position above a distribution manifold and the plurality of individually identified seeds are released from the seed extraction assembly into a plurality of reservoirs in the distribution manifold. The individually identified seeds are then placed from the distribution manifold onto the seed tape.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

The embodiments described herein may be better understood by referring to the following description in conjunction with the accompanying drawings.

FIG. 1 is a perspective view of an exemplary system for selecting an individually identified seed and placing the seed on a seed tape;

FIG. 1A is a perspective view of an exemplary seed tray;

FIG. 2 is a front view of the system of FIG. 1;

FIG. 3 is a side view of the system of FIG. 1;

FIG. 4 is a perspective view of an exemplary seed extraction assembly;

FIG. 5 is a perspective view of an exemplary distribution manifold and tamping assembly;

FIG. 6 is a top view of the distribution manifold and tamping assembly of FIG. 5;

FIG. 7 is a side view of the distribution manifold and tamping assembly of FIG. 5;

FIG. 8 is a perspective of the distribution manifold of FIG. 5 with the other components of the system omitted;

FIG. 9 is a top plan view of a portion of an exemplary seed tape;

FIG. 10 is block diagram of an exemplary controller for controlling the components of the system;

FIG. 11 is a flow diagram showing a method of placing individually identified seeds onto a seed tape.

### DETAILED DESCRIPTION

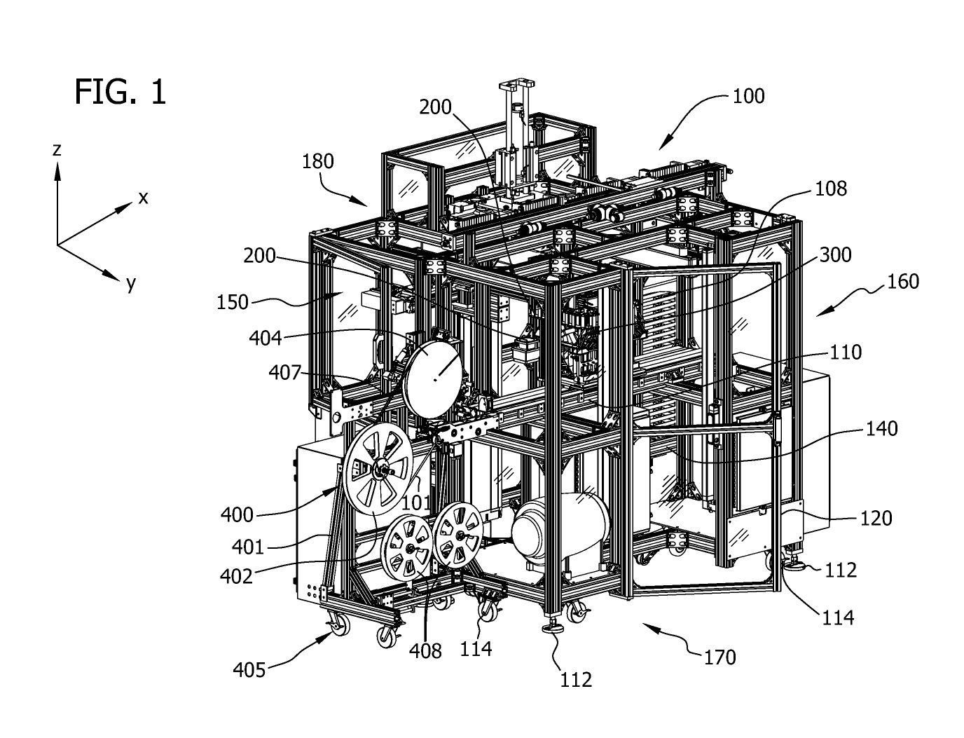

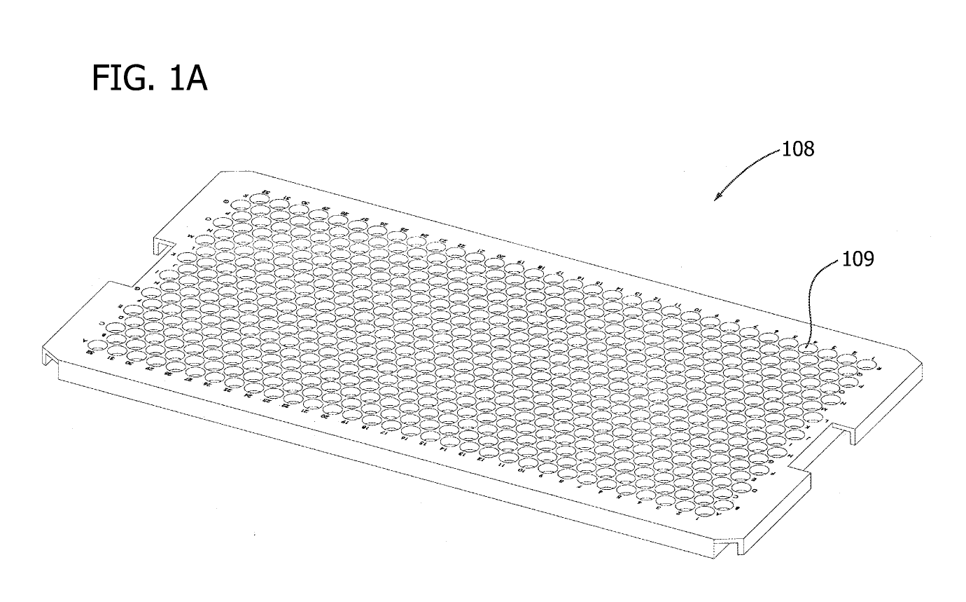

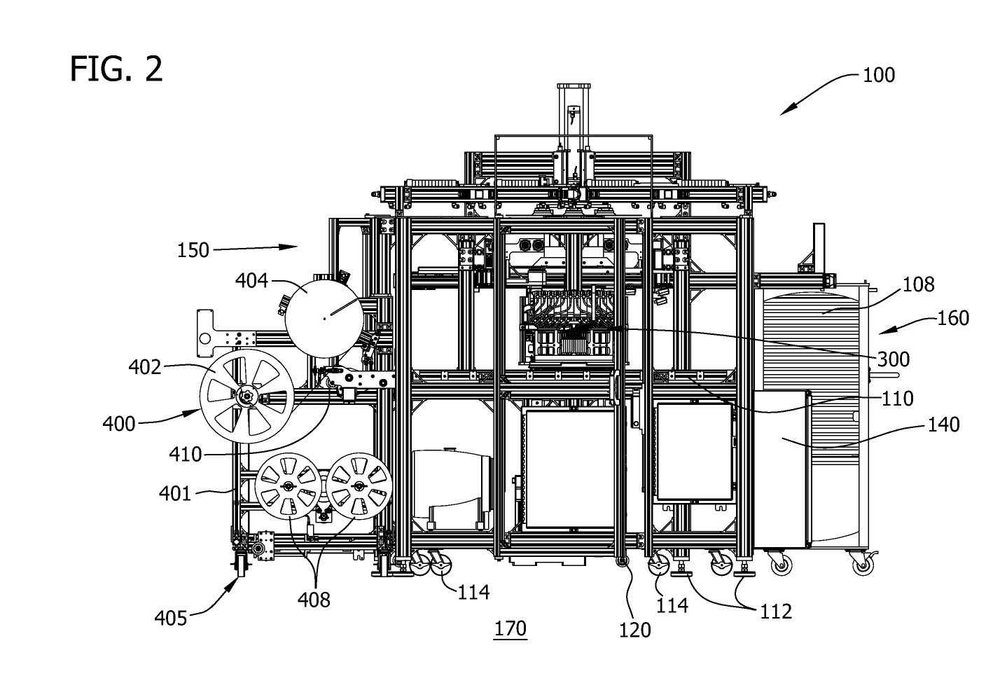

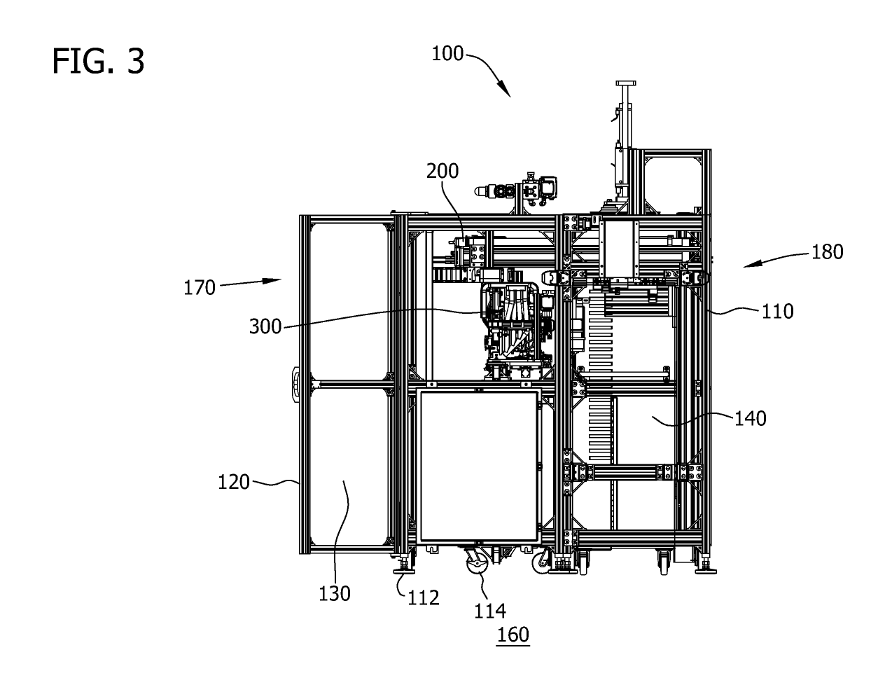

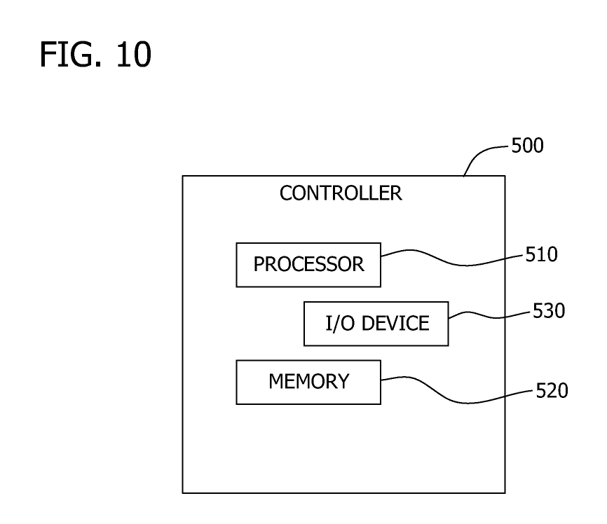

Referring to FIG. 1, an exemplary embodiment of a system 100 for selecting an individually identified seed and placing the seed on a seed tape is shown. FIG. 2 is a front view of the system 100, while FIG. 3 is a side view of the system. The system 100 broadly includes a seed extraction assembly 200 for removing an individually identified seed 102a from a seed tray 108, a placement system 300 for placing the seed 102a on a seed tape 101, and a seed tape advancing assembly 400 for feeding a substrate 104 into the placement system and removing the seed tape therefrom. The various components of the system 100 are controlled by a controller 500, as best seen in FIG. 10. The controller 500 is a computing system and includes a processor 510 for processing computer-executable instructions, a memory 520 (i.e., computer-readable media) for storing the instructions and other data, and an input/output device 530 for communicating with the components of the system 100.

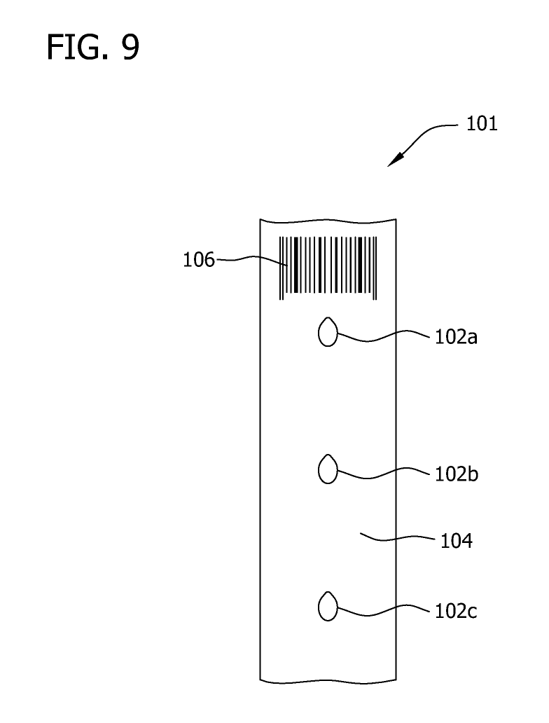

The embodiments described herein are generally directed to the placement of individually identified seeds 102a, 102b, 102c on the substrate 104 of the seed tape 101 (FIG. 9). The portion of the seed 101 shown in FIG. 9 has three individually identified seeds 102a, 102b, 102c. Broadly, the seed tape 101 may be referred to as a “seed assembly” but is referred to hereinafter as a seed tape or tape. Each seed 102a, 102b, 102c is affixed to the substrate 104 by adhesive. In other embodiments, the substrate 104 of the seed tape 101 includes holes therein. Each hole is sized smaller than the seeds 102a, 102b, 102c, to prevent the seeds from passing therethrough. The holes permit moisture in the soil to come into direct contacts with the seeds 102a, 102b, 102c. Alternatively, the seeds 102a, 102b, 102c are disposed on the substrate 104, e.g., placed in the approximate center of the seed tape 101, and the seed tape is folded over (lengthwise) to encapsulate the seeds.

Each of the seeds 102a, 102b, 102c are individually identified through an identification process. For example, each of the seeds 102a, 102b, 102c may be subject to a genetic testing process that identifies unique traits for each specific seed. Accordingly, each of the seeds 102a, 102b, 102c possesses different traits or characteristics than each of the other seeds. Moreover, while only three seeds 102a, 102b, 102c are shown in the exemplary embodiment, any number of seeds may be individually identified without departing from the scope of the embodiments. Reference herein will be made to a seed 102 for the sake of brevity, although the reference to seed 102 is intended to represent any of the individually identified seeds.

In some embodiments, the position of each of the individual seeds 102 on the substrate 104 may be randomized. An identifying indicia 106 may also be placed on the substrate 104 of the seed tape 101. The indicia 106 enables tracking and identification of a specific seed tape from production to planting. The identifying indicia 106 may be machine-readable (e.g., a barcode) in one embodiment. In other embodiments, the identifying indicia 106 may include other identification elements (e.g., a radio frequency identification tag). The identifying indicia 106 may also include information identifying each one of the seeds 102 in the seed tape 101 and their position on the substrate 104.

In certain embodiments, the systems and methods described herein are useful in breeding programs wherein seeds are selected for planting based on known or desired characteristics. For example, such breeding programs may include seeds which have been sampled and selected by automated tissue sampling and analysis as described in U.S. Pat. Nos. 7,502,113; 7,591,101 and 7,611,842, all of which are incorporated herein by reference.

The use of the identifying indicia 106 enables tracking of individual seeds 102 during their growth, thus eliminating the need for costly and time consuming tissue sampling of plants grown from the seeds. The preservation of the identity and location of the individual seeds 102 in the seed tape 101 is also useful in applications where genetic information has been collected for each individual seed, such as in the breeding programs above. The genetically identified seeds 102 are then easily tracked, as their identity and location on the substrate 104 of the seed tape 101 are known. Moreover, only specific types of genetically identified seeds may be placed within a randomized trial by placement on the substrate 104. These specific types of genetically identified seeds 102 can then be tracked because their identity and location on the substrate 104 is known.

With reference now to FIGS. 1-3, the system 100 has a frame 110 onto which the various components of the planter are attached. The frame 110 may be formed from any suitable material, such as steel. The frame 110 has multiple leveling feet 112 positioned at various points along its base. The leveling feet 112 may be extended outward from the frame 110 to contact an underlying surface on which the frame is positioned, e.g., to compensate for irregularities in the underlying surface. Casters 114 are also attached to the base of the frame 110 to facilitate movement of the frame when the leveling feet 112 are retracted upward towards the frame and not in contact with the underlying surface. The frame 110 includes multiple screened panels 130 that together with the frame form an enclosure around the system 100 to limit access to the components of the system. The enclosure of the system 100 generally defines a left side 150 and right side 160 of the system and a front side 170 and rear side 180. A door 120 permits access to the components of the system 100 when open through the front side 170. In some embodiments, the door 120 includes screened panels 130, while in other embodiments the door includes a clear panel formed from any suitable material (e.g., clear polycarbonate).

A cart 140 is positioned adjacent the right side 160 of the system 100 while the seed tape advancing assembly 400 is positioned adjacent the left side 150. In other embodiments, the positions of the cart 140 and seed tape advancing assembly 400 may be reversed. The cart 140 is mounted on multiple casters and contains at least one seed tray 108 (as best seen in FIG. 1A). The cart 140 is configured to carry multiple seed trays 108 in individual shelves. Each seed tray 108 contains multiple wells 109 into which individual seeds 102 are placed. Each well 109 is loaded with a single seed 102 during an earlier seed identification process. The seed tray 108 shown in FIG. 1A does not contain any seeds 102. During the seed identification process, the location of the well into which the seed 102 is placed is recorded along with the identifying information (i.e., specific traits or other genetic information) for the seed. Seed trays 108 are removed from the seed cart 140 and loaded into the system 100 by a tray transport assembly (not shown). In some embodiments, safety interlocks prevent the manual loading of the seed trays 108 into the system 100. In other embodiments, manual loading is not prevented.

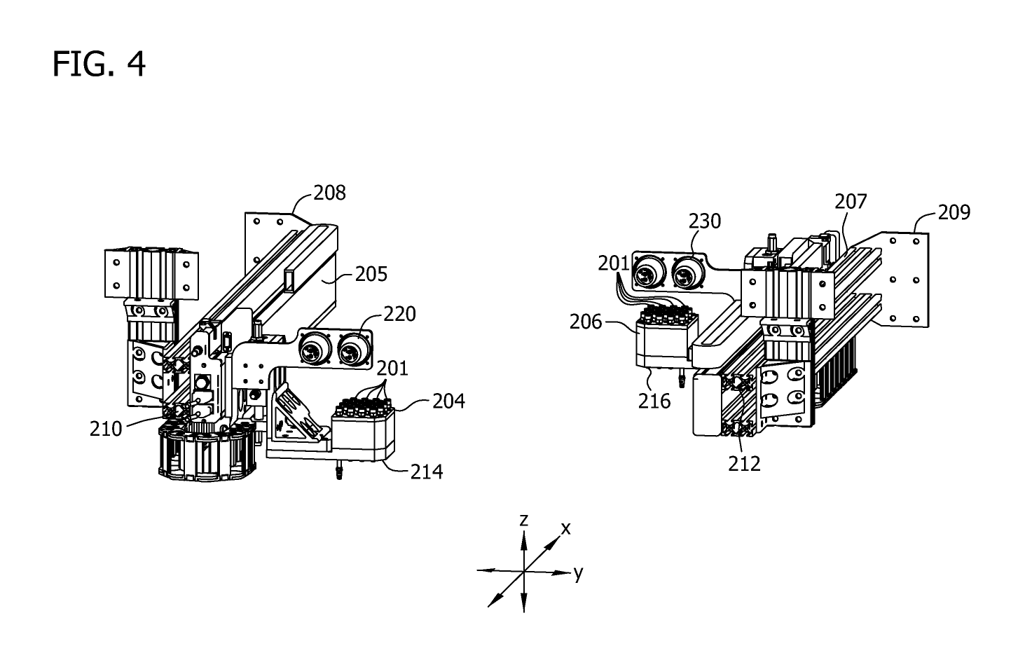

Once loaded into the system 100, seeds 102 are extracted from the wells 109 of the seed tray 108 by the seed extraction assembly, as best seen in FIG. 4. The seed extraction assembly includes a left vacuum head module 204 and a right vacuum head module 206. The vacuum head modules 204, 206 use vacuum supplied by a vacuum source to lift seeds 102 from the wells 109 of the seed tray 108. The left vacuum head module 204 is attached to a left frame 205 while right vacuum head module 206 is attached to a right frame 207. The left frame 205 is in turn attached by a left mounting plate 208 to a y-axis actuator attached to the frame 110 and the right frame 207 is attach by a right mounting plate 209 to a y-axis actuator to the frame. The left vacuum head module 204 is moved along the left frame 205 by a left x-axis actuator 210. Likewise, the right vacuum head module 206 is moved along the right frame 207 by a right x-axis actuator 212. The x-axis actuators 210, 212 and y-axis actuators are collectively referred to as a “movable transport assembly”. In some embodiments, the left mounting plate 208 and right mounting plate 209 are attached directly to the frame 110 and the seed tray 108 is movable by an actuator. Moreover, while two vacuum head modules 204, 206 are shown in the exemplary embodiment, any number of vacuum head modules may be used without departing from the scope of the embodiments.

Each of the vacuum head modules 204, 206 has a plurality of vacuum nozzles 201 extending from a respective bottom portion 214, 216 of the vacuum head module. Each of the vacuum nozzles 201 is selectively operable such that any number of the vacuum nozzles may be energized at any time. The vacuum nozzles 201 are operable to lift the seeds 102 from the wells 109 of the seed tray 108. The vacuum head modules 204, 206 may operate on a single seed tray 108 in some embodiments, while in other each vacuum head module operates on a different seed tray. The vacuum head modules 204, 206 are coupled to a vacuum source through hoses or piping (not shown) connected to respective hose connectors 220, 230 (FIG. 4).

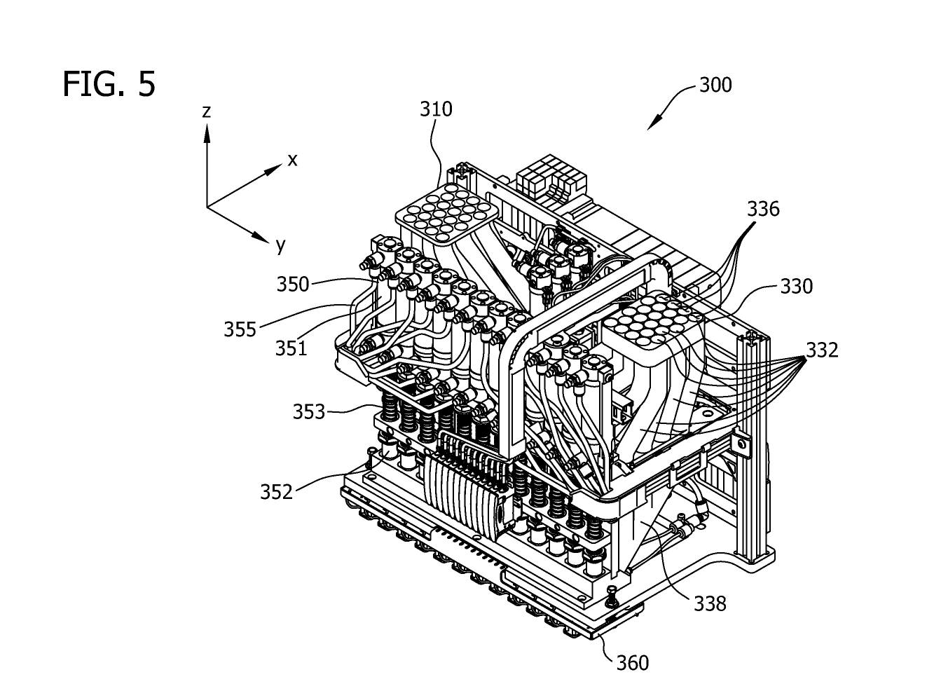

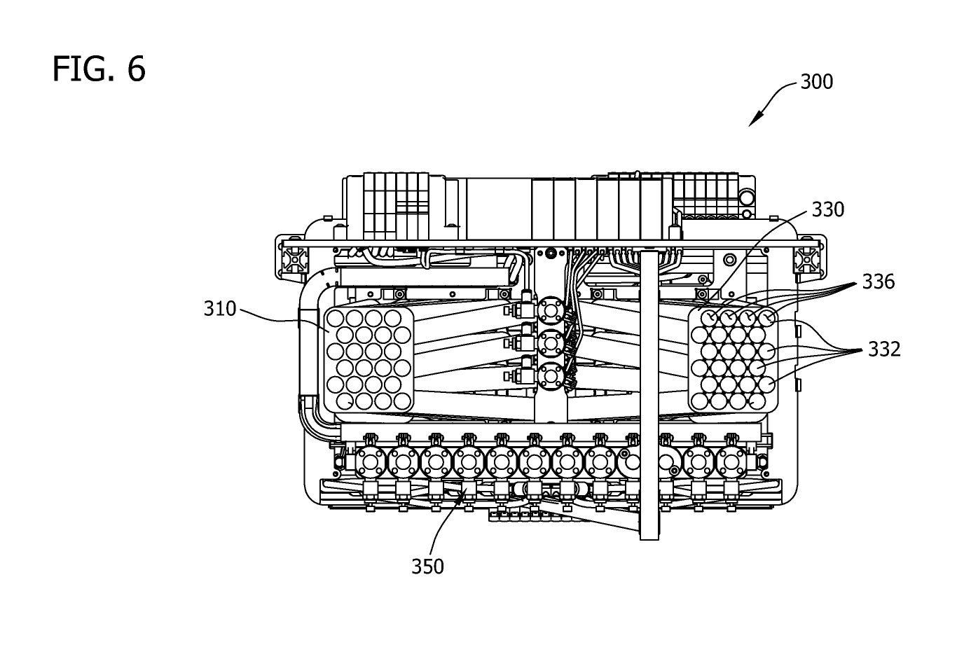

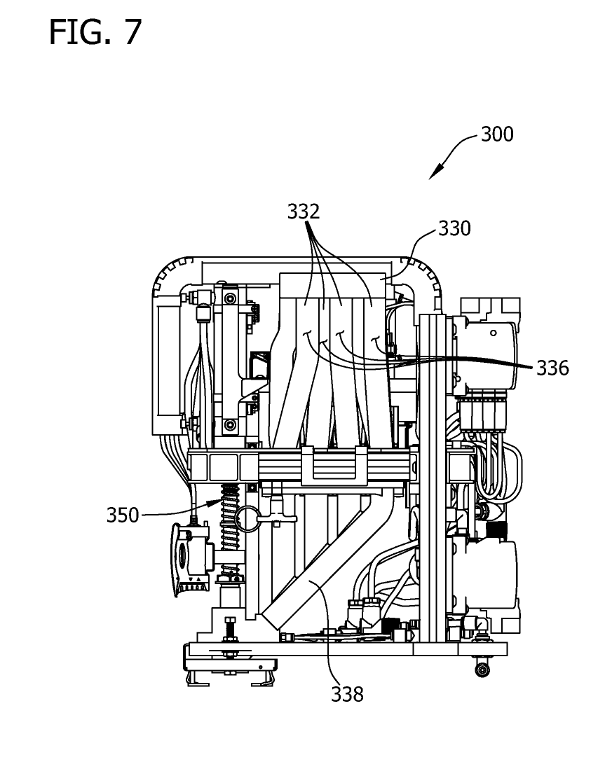

After the vacuum nozzles 201 in the vacuum head modules 204, 206 have extracted the seeds 102 from the wells 109 of the seed tray 108 the actuators 210, 212 move the head modules above the placement system 300. As best shown in FIGS. 5-8, the placement system 300 includes a left distribution assembly 310, a right distribution manifold 330, and a tamping assembly 350. The left distribution manifold and right distribution manifold 310, 330 are mirror images of each other, and reference is made herein to the right distribution manifold for the purposes of describing the operation thereof. Accordingly, the left distribution manifold 310 has the same components that function in the same manner as those in the right distribution manifold.

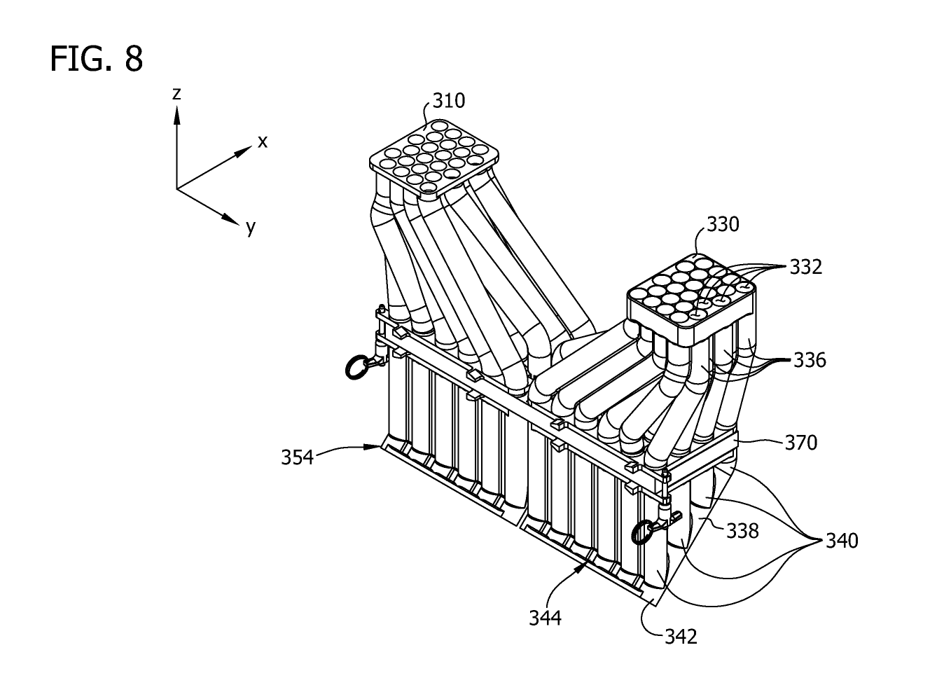

As best shown in FIG. 8, the right distribution manifold has a plurality of reservoirs 336 that extending into a plurality of tubes 338. Each of the tubes 338 also has a plurality of upper tubes 340 that extend upward to meet the plurality of reservoirs. The reservoirs 336 are grouped into queues 332, with each of the queues feeding into a different group of upper tubes 340 that in turn feed into one of the tubes 338. Each of the reservoirs 336 in a particular queue 332 is in selective communication with its respective plurality of upper tubes 340 and corresponding tube. Each of the tubes 338 has a respective tube outlet 342, and the tubes are grouped into a left tube assembly 344 and a right tube assembly 354.

According to some embodiments, the plurality of reservoirs 336 in each of the distribution manifolds 310, 330 are spaced apart from each other in the same arrangement as each of the vacuum nozzles 201 in the vacuum head modules 204, 206. Accordingly, in these embodiments there is a one-to-one correspondence between the reservoirs 336 and the vacuum nozzles 201 such that when the vacuum head modules 204, 206 are placed over the reservoirs seed carried by the vacuum nozzles may be released and dropped directly into the reservoirs 336 without the need for a funnel or any other intervening structure.

Valves 370 are used to control the selective communication between the reservoirs 336 and upper tubes 340. Each of the valves 370 is independently controlled (i.e., controlled separately from the other valves). In the exemplary embodiment, the valves 370 are gate valves, while in other embodiments the valves may be different types of valves without departing from the scope of the embodiments. In a typical arrangement, the valves 370 are constructed such that they are in normally closed state that does not permit communication between the reservoirs 336 and upper tubes 340. Positive actuation of the valves 370 is thus required to permit seeds 102 deposited into the reservoirs 336 to be fed or pass into the upper tubes 340 and corresponding tubes 338. In other embodiments, the valves 370 may function in an opposite manner and be in a normally open state that requires positive actuation of the valves to keep them closed.

Once seeds 102 pass through the tube outlets 342, they are placed on the substrate 104 of the seed tape 101 by the tamping assembly 350, as best seen in FIGS. 5-7. The tamping assembly 350 includes multiple pneumatic cylinders 351 connected by corresponding piping 355 to a gas source. A separate pneumatic cylinder 351 is provided for each of the tubes 338 and is positioned adjacent the tube outlet 340 of each tube. Each pneumatic cylinder 351 includes a corresponding piston 352. The piston 352 are biased into a retracted state by a spring 353. The pistons 352 are forced downward toward the tube outlets 340 upon the actuation of the pneumatic cylinders 351. The pneumatic cylinders 351 are actuated upon their supply with a compressed gas (e.g., air or nitrogen) by the gas source through the piping 355. Accordingly, one seed 102 falls from the tube outlet 340, the piston 352 is forced downward by the actuation of the pneumatic cylinder 351. The downward motion of the piston 352 presses the seed 102 against the substrate 104 of the seed tape 101. The substrate 104 is supported on its underside by a tamping plate 360. During pressing of the seed 102 onto the substrate by the piston 352, the tamping plate 360 thus supports the substrate and prevents it from tearing or otherwise being damaged. In other embodiments, the cylinders 351 may not be pneumatic, and instead are actuated by a fluid (e.g., hydraulic fluid) without departing from the scope of the embodiments. Moreover, the cylinders 351 and pistons 352 may not be used to place seeds 102 on the substrate 104. Instead, electro-mechanical actuators may be used to place the seeds 102 on the substrate 104 without departing from the scope of the embodiments.

The seed tape advancing assembly 400 (hereinafter referred to as the “assembly 400), as best seen in FIGS. 1-3, moves the substrate through the system. The assembly 400 includes a frame 401 onto which the components of the assembly are mounted. The frame 401 has four casters 405 mounted on its bottom portion to facilitate movement of the assembly 400. Unused substrate 104 is contained on a substrate payoff wheel 402. As the substrate 104 is dispensed from the payoff wheel 402, the moves laterally to the right, as shown in FIG. 1. Adhesive is then placed on the substrate 140 by the adhesive payoff wheel 404. An adhesive strip 407 is reeled off the adhesive payoff wheel 404 and brought into contact with the substrate 104 at select locations. In some embodiments, the select locations are equally spaced apart on the substrate 104 at regular intervals (e.g., one to six inches). The substrate 104 may have indexing marks placed thereon during its manufacture. The indexing marks are spaced from each other at regular intervals and adhesive is placed on the substrate 104 at the indexing marks by the adhesive payoff wheel 404. The indexing marks may also define where on the substrate 104 each of the seeds 102 are to be placed.

According to some embodiments, the adhesive is not used to secure the seeds 102 to the substrate 104. Instead, a multilayered substrate is used that includes a first layer and a second layer having multiple openings in a honey-combed arrangement. The openings in the first and second layers are smaller than the diameter of the seeds 102 to prevent the seeds from passing therethrough. Seeds 102 are placed on the first layer, and the seeds and first layer are covered by the second layer. Either the first layer or the second layer may have adhesive disposed thereon to bind the layers together. In some embodiments, the first layer and second layer are pressed together by a mechanism similar to the tamping assembly 350. In these embodiments using the multi-layered substrate, the seeds 102 are effectively “sandwiched” between the layers of the substrate. In other embodiments, the substrate 104 is folded lengthwise around the seeds 102 and adhesive is used to bond the substrate into the folded configuration, without applying adhesive directly to the seeds.

The substrate 104 is moved laterally to the right through the system 100 after the placement of adhesive on the substrate by the adhesive payoff wheel 404. The substrate 104 is then brought into contact with the placement system 300 and seeds 102 are placed thereon, resulting in the formation of the seed tape 101. The seed tape 101 then returns to the assembly 400 and is wound around one of two seed tape take-up rolls 408. Rotation of a pull-nip roll 410 pulls the substrate 104 off of the substrate payoff wheel 402 and pulls the substrate through the system 100. The seed tape take-up rolls 408 and the pull-nip roll 410 may be rotated by any suitable drive source (e.g., a motor). In other embodiments, the substrate 104 may be advanced through the system 100 may any suitable mechanism and the pull-nip roll 410 are not used to pull the substrate through the system. The assembly 400 also includes one or more mechanisms to apply identifying indicia 106 to the seed tape 102, according to some embodiments.

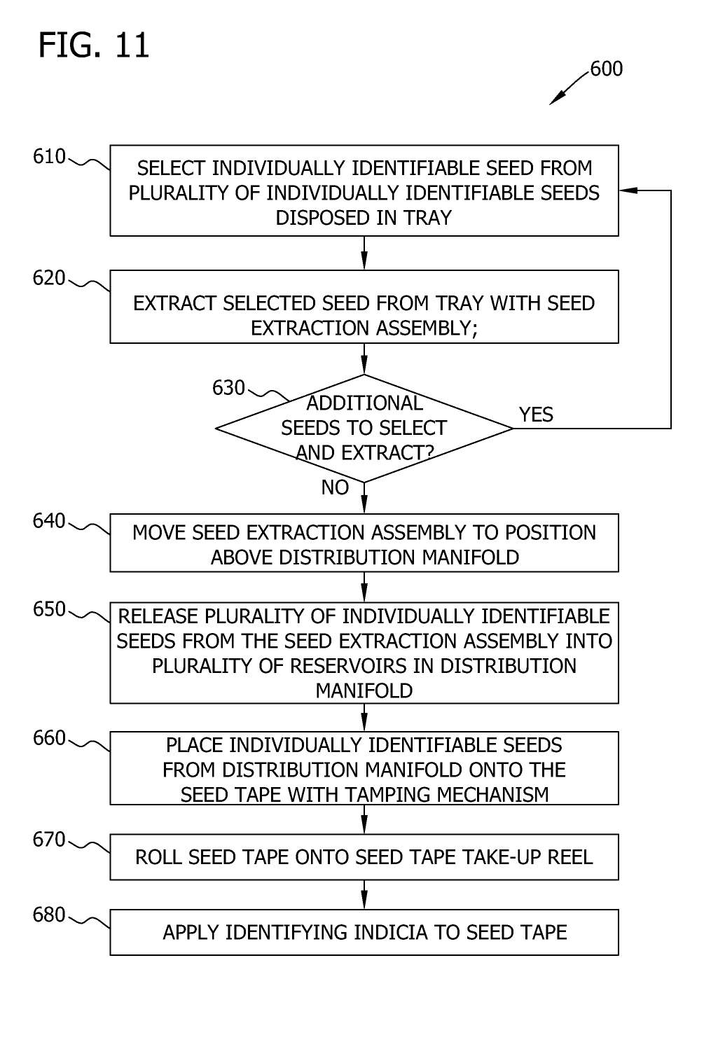

FIG. 11 shows an example method 600 of operating the system 100 to place individually identified seeds 102 onto the seed tape 101. The method 600 is described herein with reference to a single vacuum head of the seed extraction assembly 200. Other embodiments may use both of the vacuum heads of the seed extraction assembly 200 without departing from the scope of the embodiments.

Prior to the commencement of the method 600, the substrate 104 is threaded through the system 100. A portion of the substrate 104 is first unwound from the substrate payoff wheel 402 and threaded into the tamping assembly 350 between the pistons 352 and the tamping plate 360. The substrate 104 is then wound around either of the seed tape take-up wheel 408. During the method 600, the substrate 104 may be advanced through the system 100 either by rotating the seed tape take-up wheel 408 with a drive source or by any other suitable mechanism to push or pull the substrate through the system. Moreover, the seed tray 108 may be removed from the cart 140 by a tray transport assembly (not shown) and replaced with another seed tray from the cart once seeds 102 have been removed from the wells 109.

The method begins at block 610 with the selection of a single individually identified seed 102 from the plurality of individually identified seeds disposed in the wells 109 of the seed tray 108. In selecting the seed 102, a database or other list stored on the memory 520 of the controller 500 is consulted to determine an order of the locations where each seed 102 is to be placed on the substrate 104. The database contained on the memory 520 may include a one-to-one correlation between each of the seeds 102 and their desired location on the substrate 104. Moreover, the processor 510 may randomize the locations of the seeds 102 on the substrate and record the randomized locations in another database stored on the memory 520.

The method 600 proceeds to block 620 where the selected seed 102 is extracted from the tray 108 with the seed extraction assembly 200. The seed extraction assembly 200 and the vacuum head modules 204, 206 may be operated according to at least two different procedures. In a first procedure, the vacuum head modules 204, 206 are positioned over the seed tray 108 such that each vacuum nozzle is positioned over a corresponding single well. The vacuum nozzles 201 are then energized and each seed 102 positioned beneath each nozzle is then lifted from the seed tray 108. The seeds 102 then retain the same relative arrangement with respect to each other as that which they had when positioned in the wells 109 of the seed tray 108. In the other procedure, the vacuum head modules 204, 206 are positioned such that at least one of the vacuum nozzles 201 is positioned over a single well in the seed tray 208. The vacuum nozzle is then activated and a single seed 102 is removed from the well of the seed tray 108. The vacuum head modules 204, 206 are then moved and the process is repeated with a different vacuum nozzle being positioned over a different well in the seed tray 108. The process continues and individual seeds are removed from the wells 109 of the seed tray 108. In this procedure, the seeds 102 do not retain the same relative arrangement with respect to each other as they had when positioned in the wells 109 of the seed tray 108. The method 600 contemplates extracting seeds 102 using the first process, although other embodiments may use the second seed extraction process without departing from the scope of this disclosure.

A determination is then made in block 630 as to whether additional seeds 102 remain to be extracted from the seed tray 108. The database stored on the memory 520 of the controller 500 may be consulted to determine which seeds have already been extracted and which seeds still require extraction from the seed tray. If seeds 102 remain in the seed tray 108 for extraction, the method 600 returns to block 610. However, if there are no additional seeds to extract from the seed tray the method 600 proceeds to block 640.

In block 640, the seed extraction assembly 200 is moved into position above the either of the distribution manifolds 310, 330. The seed extraction assembly 200 is moved by any of the actuators described above in relation to FIG. 4. According to some embodiments, the extraction assembly 200 is positioned above the distribution manifolds 310, 330 such that vacuum nozzles 201 are in vertical alignment with each of the reservoirs 336.

The plurality of seeds 102 carried by the seed extraction assembly 200 are then released into the reservoirs 336 of the distribution manifolds 310, 330 in block 650. The seed extraction assembly 200 releases the seeds 102 by reducing or eliminating the vacuum supplied to the vacuum nozzles 201. In some embodiments, positive pressure may be supplied to the vacuum nozzles 201 to push the seeds 102 out from the nozzles.

The seeds 102 are then placed onto the substrate 104 of the seed tape 101 by the tamping assembly 350 in block 660. Seeds 102 are transported to the tamping assembly by selective actuation of the valve members 370. To move a particular seed 102 from a reservoir 336, the valve member 370 controlling the flow from the particular reservoir to the upper tube 340 is opened. The seed 102 then falls through the upper tube 340 into the tube 338. The seed falls through the corresponding tube outlet 342 and into contact with piston 352 of the tamping assembly 350. Compressed gas (or another suitable working fluid) is supplied to the cylinder 351 and acts against the piston 352 to press the piston down and press the seed 102 onto the substrate 104. After the piston 352 has pressed the seed 102 onto the substrate 104, the flow of compressed gas to the cylinder 351 is stopped and the spring 353 returns the piston 352 to its original position. The process of block 660 is repeated or occurs simultaneously for one reservoir 336 in each of the queues 332. The seed tape 101 is then advanced by the seed tape advancing assembly 400. After being advanced through the tamping assembly 350, the seed tape 101 is wound around the seed tape take-up roll 408 in block 670.

The process of block 660 then repeats itself for another reservoir 336 in each of the queues 332, after which the seed tape 101 is again advanced. This process continues until all of the reservoirs 336 are emptied of seed 102. Alternatively, while the seeds 102 are being placed on the seed tape 101, the empty reservoirs 336 may be re-filled with additional seeds 102 by the seed extraction assembly 200. Accordingly, the method 600 may continue until either the supply of substrate 104 is exhausted or until all of the seeds 102 disposed in the seed trays 108 are placed on the seed tape 101.

In block 680, the identifying indicia 106 is applied to the seed tape. As described above, the identifying indicia 106 provides a mechanism to track and identify a specific seed tape 101 from production to planting. The indicia 106 may also include information identifying each one of the seeds 102 in the seed tape 101 and their position on the substrate 104. According to some embodiments, the identifying indicia 106 is applied or affixed to the seed tape 101 before or after the placing of seed 102 thereon by an identification assembly (not shown).

This written description uses examples to disclose the invention, including the best mode, and also to enable any person skilled in the art to practice the invention, including making and using any devices or systems and performing any related methods. The patentable scope of the invention may include other examples that occur to those skilled in the art. Such other examples are intended to be within the scope of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of the present invention or the embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

What is claimed is:

1. A system for selecting individual seeds from a plurality of seeds and placing the selected individual seeds on a seed tape, the system comprising:
a seed extraction assembly configured to extract selected individual seeds from a tray, the seed extraction assembly movably attached to a frame;
a distribution manifold having a plurality of queues, each of the plurality of queues having a plurality of reservoirs for receiving the selected individual seeds, each queue having a tube in selective communication with the plurality of reservoirs for the transfer of the selected individual seed from the reservoir to the tube, the distribution manifold attached to the frame; and
a tamping assembly attached to the frame adjacent the distribution manifold, the tamping assembly configured to place the selected individual seed disposed in each of the tubes onto a defined location on the seed tape.

2. The system of claim 1 wherein the seed extraction assembly includes a vacuum head module.

3. The system of claim 2 wherein the vacuum head module has a plurality of spaced-apart vacuum nozzles.

4. The system of claim 1 wherein the seed extraction assembly is movable relative to the tray.

5. The system of claim 3 wherein the spacing between the plurality of vacuum nozzles corresponds to a spacing between the plurality of reservoirs.

6. The system of claim 1 further comprising a plurality of valves for controlling the selective communication between the plurality of reservoirs in each queue with the corresponding tube for each queue.

7. The system of claim 3 wherein the number of vacuum nozzles correspond to the number of reservoirs in the distribution manifold

8. The system of claim 6 further comprising a controller for controlling the operation of the seed extraction assembly, the plurality of valves, and the tamping assembly.

9. The system of claim 1, further comprising an identification assembly for affixing identifying indicia to the seed tape, the identifying indicia including information describing the position of each of the selected individual seeds within the seed tape.

10. The system of claim 1 further comprising a seed tape advancing mechanism for advancing the seed tape from a substrate payoff wheel to a position in contact with the tamping assembly and advancing the seed tape onto a seed tape take-up roll after the tamping assembly has placed one or more of the selected individual seeds onto the seed tape.

11. The system of claim 10 wherein the seed tape advancing mechanism is configured to place adhesive on the seed tape.

12. A system for the transfer of individually identified seeds from a tray onto a seed tape, the system comprising:
a seed extraction assembly for the extraction of the individually identified seeds from the tray, the seed extraction assembly movable relative to a frame, the tray disposed within the frame;
a distribution manifold having a plurality of queues, each of the plurality of queues having a plurality of reservoirs for receiving individually identified seeds from the seed extraction assembly, each queue having a tube selectively fed with individually identified seeds from one of the plurality of reservoirs in the queue, the distribution manifold attached to the frame; and
a tamping assembly for placing individually identified seeds from the tubes onto the seed tape.

13. The system of claim 12 wherein the seed extraction assembly is a vacuum head module having a plurality of spaced-apart vacuum nozzles.

14. The system of claim 13 wherein the vacuum head module is attached to a movable transport assembly for moving the vacuum head module relative to the frame, the movable transport assembly attached to the frame.

15. The system of claim 12 wherein the tray is one of a plurality of trays, at least some of the plurality of trays are disposed in a cart adjacent the frame.

16. The system of claim 15 wherein the trays are movable from the cart to within the frame by a tray transport assembly.

17. The system of claim 13 wherein the vacuum nozzles are spaced apart from each other in an arrangement corresponding to an arrangement of the reservoirs.

18. The system of claim 12 further comprising a plurality of valve members for controlling the selective feeding of the individually identified seeds from the plurality of reservoirs in each queue with the corresponding tube for each queue.

19. The system of claim 13 wherein the vacuum head module is a left vacuum head module, the system further comprising a right vacuum head module.

20. The system of claim 12 wherein the distribution manifold is a left distribution manifold, the system further comprising a right distribution manifold.

21. The system of claim 12 wherein the tamping assembly presses the individually identified seeds onto the seed tape.

22. The system of claim 12 wherein the tamping assembly is configured to affix identifying indicia to the seed tape, the identifying indicia including information describing the position of each of the individually identified seeds within the seed tape.

23. A method of placing individually identified seeds onto a seed tape, the method comprising:
(i) selecting an individually identified seed from a plurality of individually identified seeds disposed in a tray;
(ii) extracting the selected seed from the tray with a seed extraction assembly;
(iii) repeating steps (i) and (ii) for a plurality of individually identified seeds;
(iv) moving the seed extraction assembly to a position above a distribution manifold;
(v) releasing the plurality of individually identified seeds from the seed extraction assembly into a plurality of reservoirs in the distribution manifold; and
(vi) placing the individually identified seeds from the distribution manifold onto the seed tape.

24. The method of claim 23, further comprising rolling the seed tape onto a seed tape take-up roll after the individually identified seeds are placed onto the seed tape.

25. The method of claim 23, further comprising applying identifying indicia to the seed tape.
